(19) United States
(12) Patent Application Publication
(10) Pub. No.: US 2005/0277326 A1
(43) Pub. Date: Dec. 15, 2005

(54) Battery connector

(76) Inventor: Wen-Lung Chung, Taichung City (TW)

Correspondence Address: TROXELL LAW OFFICE PLLC, SUITE 1404, 5205 LEESBURG PIKE, FALLS CHURCH, VA, 22041, US

(21) Appl. No.: 10/863,280

(22) Filed: Jun. 9, 2004

(51) Int. Cl. H01R 3/00

(52) U.S. Cl. 439/500

(57) ABSTRACT

A battery connector includes a housing, two sidewalls extending from opposite sides of the housing, and a plurality of latches thereby defining a receiving chamber for receiving a battery therein. Each latch has a securing portion extending into the receiving chamber for securing the battery. At least one securing portion of the latch has a guiding surface for guiding the battery to readily extend into the receiving chamber. Two electrically conductive contacts are attached to the housing. Each contact has one end extending into the receiving chamber for electrically connecting with an electrode of the battery, and the other end extending oppositely and exposed to the bottom surface of the housing for mounting on and electrically connecting with a PCB. The height of each contact extending into the receiving chamber is less than the height of the latch.

### BACKGROUND OF THE INVENTION

1. Field of the Invention

The present invention relates to an electrical connector, and particularly to a battery connector for connecting a battery to a printed circuit board (PCB).

2. Prior Art

In general, a buttony battery is assembled to a printed circuit board (PCB) of an electronic device through soldering. The battery is a lithium battery. So the battery cannot be assembled to the PCB during the PCB passing through a tin oven for preventing from short circuit. Therefore, the battery has to be artificially soldered to the PCB after the PCB pass through the tin oven, which is low efficient and does not facilitate mass production. Furthermore, the battery may leak electricity during the soldering.

To encounter the above problems, a battery connector is provided as shown in FIG. 1. The battery connector is soldered to the PCB during the PCB passing through the tin oven. Then, the battery is assembled to the battery connector, which increases the assembling efficiency and prevents the battery from leaking electricity. Furthermore, it is ready to replace the battery when it is worn out. In operation, the battery is assembled to the battery connector in the manner as shown in the broken lines of FIG. 1. In detaching the battery from the battery connector, the exposing electrode of the battery is pushed and then the battery is ejected from the connection position through the resilient force of a contact of the battery connector exerting to another electrode of the battery.

However, as miniaturization of an electronic device, another PCB or a keyboard may be placed on the battery, which makes the exposing electrode and the top surface of the battery easy to be short circuit. Furthermore, the exposing electrode is ready to be pushed at some extent, which causes the battery is ejected from the connection position and so results in power cut. Therefore, the conventional battery connector is required to be improved.

### SUMMARY OF THE INVENTION

Accordingly, an object of the present invention is to provide a battery connector which prevents from improperly ejecting a battery therefrom and prevents the battery from short circuit.

Another object of the present invention is to provide a battery connector having an anti-mismating device for preventing from mismating with a PCB.

To achieve the above-mentioned objects, a battery connector in accordance with the present invention includes a housing, two sidewalls extending from opposite sides of the housing, and a plurality of latches thereby defining a receiving chamber for receiving a battery therein. Each latch has a securing portion extending into the receiving chamber for securing the battery. At least one securing portion of the latch has a guiding surface for guiding the battery to readily extend into the receiving chamber. Two electrically conductive contacts are attached to the housing. Each contact has one end extending into the receiving chamber for electrically connecting with an electrode of the battery, and the other end extending oppositely and exposed to the bottom surface of the housing for mounting on and electrically connecting with a PCB. The height of each contact extending into the receiving chamber is less than the height of the latch.

Other objects, advantages and novel features of the present invention will be drawn from the following detailed embodiments of the present invention with attached drawings, in which:

### BRIEF DESCRIPTION OF THE DRAWINGS

FIG. 1 is a schematic view of a conventional battery connector;

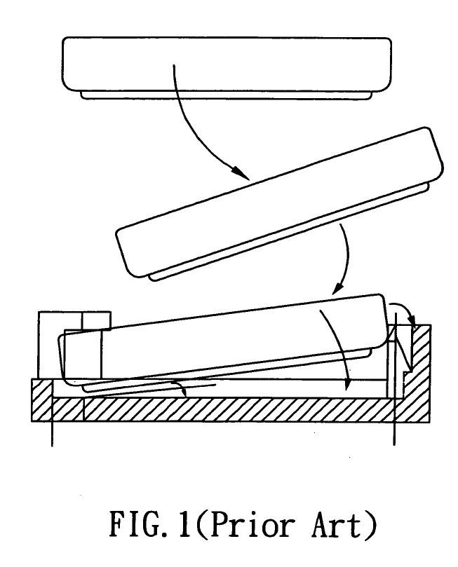

FIG. 2 is a perspective view of a battery connector of the present invention;

FIG. 3 is a schematic view showing a battery being assembled to the battery connector;

FIG. 4 is a bottom plan view of a battery connector showing an anti-mismating device in accordance with a first embodiment of the present invention;

FIG. 5 is a bottom plan view of a battery connector showing an anti-mismating device in accordance with a second embodiment of the present invention; and

FIG. 6 is a bottom plan view of a battery connector showing an anti-mismating device in accordance with a third embodiment of the present invention.

### DESCRIPTION OF THE PREFERRED EMBODIMENTS

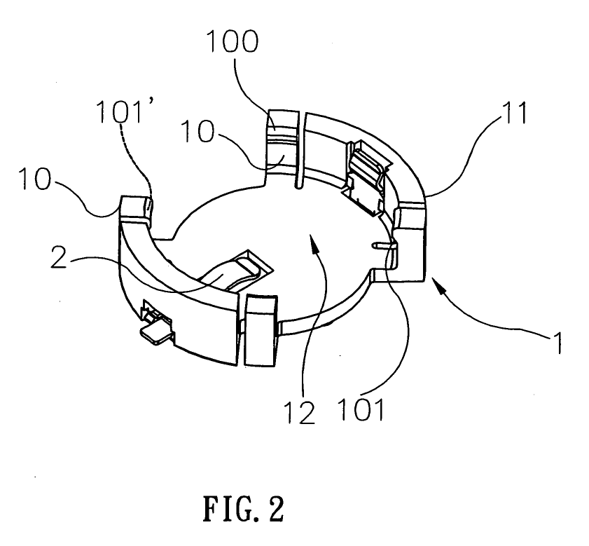

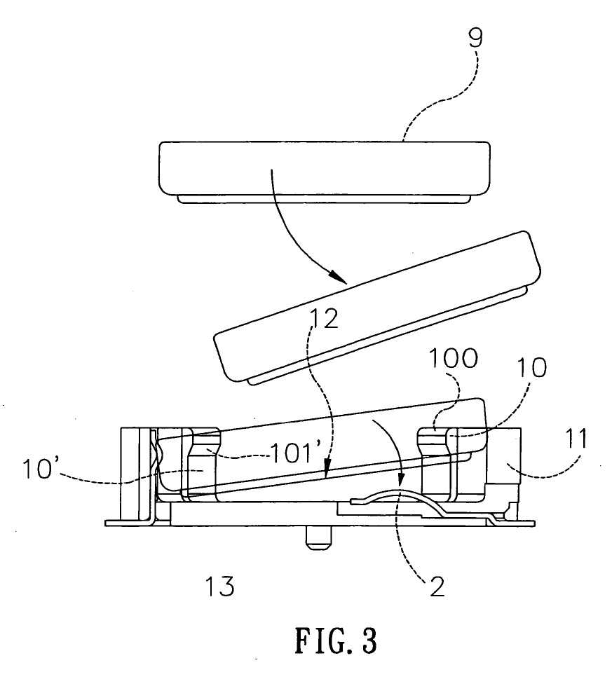

Referring to FIG. 2, a battery connector in accordance with an embodiment of the present invention includes a housing 1, two sidewalls 11 extending from opposite sides of the housing 1, and four latches 10, 10′ respectively adjacent to the sidewalls 11 thereby defining a receiving chamber 12 for receiving a battery 9 therein (see FIG. 3). The latches 10, 10′ are symmetrically formed around the receiving chamber 12. Each latch 10, 10′ has a securing portion 101, 101′ extending into the receiving chamber 12 for securing the battery 9 when the battery 9 is received in the receiving chamber 12. At least one securing portion 101, 101′ of the latch 101, 101′ has a guiding surface 100 for guiding the battery 9 to readily extend into the receiving chamber 12.

Two electrically conductive contacts 2 are attached to the housing 1. Each contact 2 has one end extending into the receiving chamber 12 for electrically connecting with an electrode of the battery 9, and the other end extending oppositely and exposed to the bottom surface of the housing 1 for mounting on and electrically connecting with a PCB (not shown). The height of each contact 2 extending into the receiving chamber 12 is less than the height of the latch 10, 10′. So the contact 2 doesnot project from the battery 9 for preventing the contact 2 from contacting with other circuit.

In the above embodiment of the present invention, the battery connector has four symmetrical latches 10, 10′. Alternatively, the battery connector may include three latches 10, 10′ for fittingly securing the battery 9 therebetween. Each securing portion 101, 101′ of the latch 10, 10′ may have a guiding surface 100.

As shown in FIG. 3, in operation, the battery 9 is slantingly inserted into the receiving chamber 12 to abut the latches 10′. The battery 9 is then pressed to slide along the guiding surfaces 100 of the securing portions 101 and then into the receiving chamber 12. Thus, the securing portions 101, 101′ of the latches 10, 10′ secure the battery 9 in the receiving chamber 12.

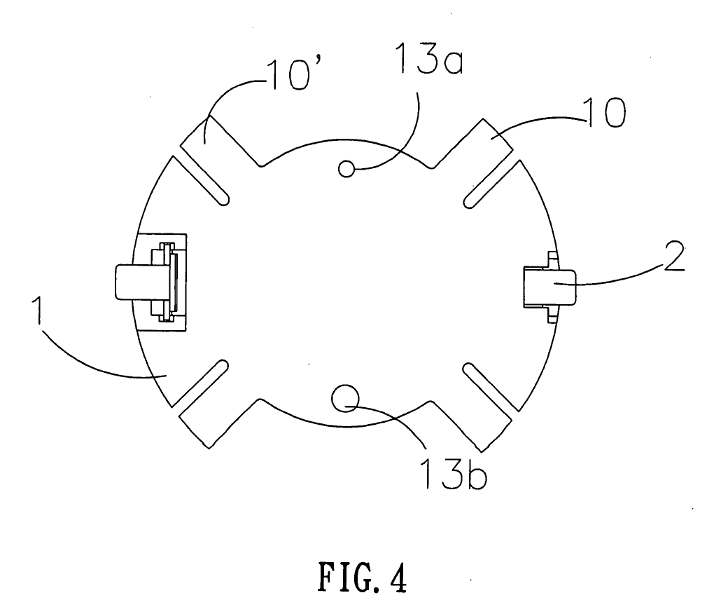

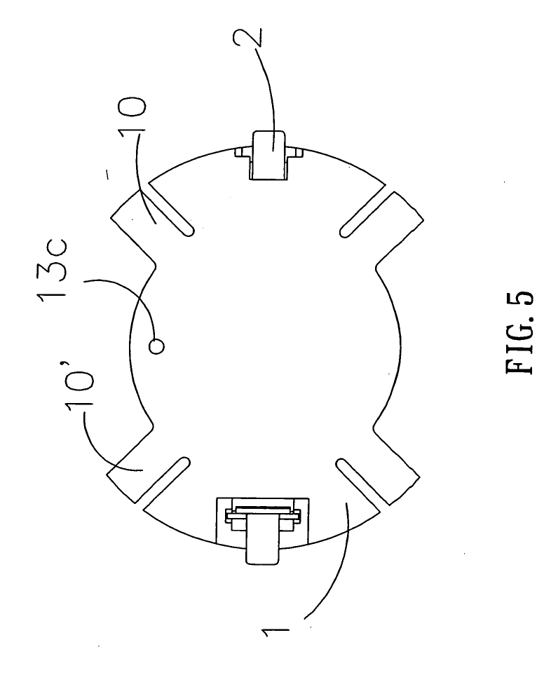

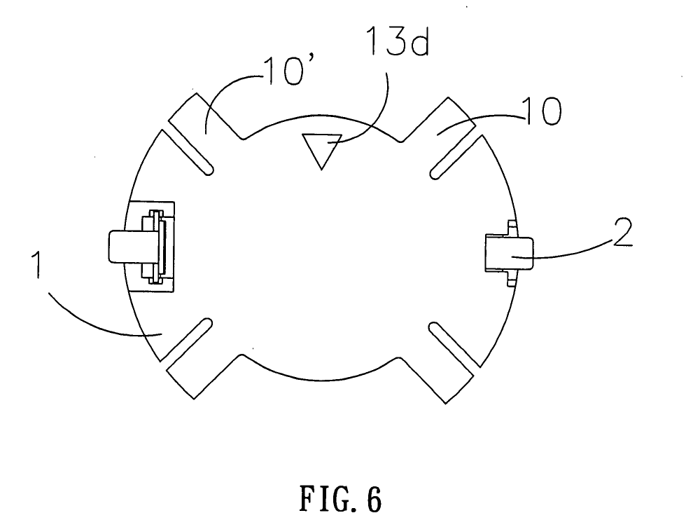

In addition, an anti-mismating device 13 is formed at the bottom surface of the housing 1 for preventing from mismating the battery connector to the PCB. As to the design of the anti-mismating device, it is configured in an unsymmetrical manner. As shown in FIG. 4, an anti-mismating device 13 in accordance with a first embodiment of the present invention includes two posts 13a, 13b with different diameters. Thus, the battery connector can only mate to the PCB in the right direction thereby preventing the battery connector from mismating to the PCB. As shown in FIG. 5, an anti-mismating device in accordance with a second embodiment of the present invention includes a cylindrical post 13c at one side of the bottom surface of the housing 1. As shown in FIG. 6, an anti-mismating device in accordance with a third embodiment of the present invention includes a triangular post 13d at one side of the bottom surface of the housing 1.

The battery connector of the present invention may be applied to an electronic device, such as a mobile phone, a notebook computer or a home appliance and so on, for connecting a battery with the electronic device. Since the battery connector is formed in the electronic device and is not convenient to check the battery in use, it is quite important to prevent the battery from ejecting from the connecting position or short circuit. As mentioned above, the battery connector of the present invention can prevent from improperly ejecting the battery from the connecting position and prevent the battery from short circuit. Furthermore, the battery connector of the present invention can prevent from mismating to the PCB.

It is understood that the invention may be embodied in other forms without departing from the spirit thereof. Thus, the present examples and embodiments are to be considered in all respects as illustrative and not restrictive, and the invention is not to be limited to the details given herein.

1. A battery connector comprising a housing, two sidewalls extending from opposite sides of the housing, and a plurality of latches thereby defining a receiving chamber for receiving a battery therein each latch having a securing portion extending into the receiving chamber for securing the battery, at least one securing portion of the latch having a guiding surface for guiding the battery to readily extend into the receiving chamber, two electrically conductive contacts being attached to the housing, each contact having one end extending into the receiving chamber for electrically connecting with an electrode of the battery, and the other end extending oppositely and exposed to the bottom surface of the housing for mounting on and electrically connecting with a PCB, the height of each contact extending into the receiving chamber being less than the height of the latch.

2. The battery connector as claimed in claim 1, wherein the plurality of latches is respectively adjacent to the sidewalls.

3. The battery connector as claimed in claim 1, wherein an anti-mismating device is formed at the bottom surface of the housing for preventing the battery connector from mismating to the PCB.

4. The battery connector as claimed in claim 3, wherein the anti-mismating device includes at least one post configured at the bottom surface of the housing in an unsymmetrical manner.

5. The battery connector as claimed in claim 1, wherein the latches are symmetrically formed around the receiving chamber.

6. A battery connector comprising a housing, two sidewalls extending from the housing, and a plurality of latches thereby defining a receiving chamber, each latch having a securing portion, two electrically conductive contacts being attached to the housing, an anti-mismating device being formed at the bottom surface of the housing.

7. The battery connector as claimed in claim 6, wherein the anti-mismating device includes a post unsymmetrically configured.

8. The battery connector as claimed in claim 6, wherein the anti-mismating device includes a plurality of posts with different diameters.

9. The battery connector as claimed in claim 6, wherein the latches are symmetrically formed around the receiving chamber.
